(19) United States
(12) Patent Application Publication
(10) Pub. No.: US 2017/0274455 A1
(43) Pub. Date: Sep. 28, 2017

(54) METHOD FOR PRODUCING A THREE-DIMENSIONAL OBJECT

(71) Applicant: CL SCHUTZRECHTSVERWALTUNGS GMBH, Lichtenfels (DE)

(72) Inventor: Frank HERZOG, Lichtenfels (DE)

(73) Assignee: CL Schutzrechtungs GmbH, Lichtenfels (DE)

(21) Appl. No.: 15/505,842

(22) PCT Filed: Aug. 18, 2015
(86) PCT No.: PCT/EP2015/068938

§ 371 Date: Feb. 22, 2017

(30) Foreign Application Priority Data
Aug. 22, 2014 (DE) 10 2014 012 425.8

(51) Int. Cl. B22F 3/105; B33Y 10/00; B29C 67/00

(52) U.S. Cl. CPC B22F 3/1055; B29C 67/0077; B29C 67/0092; B33Y 10/00; B22F 2003/1042

(57) ABSTRACT

A method for producing a three-dimensional object by successive solidification of layers of a powder-type construction material that can be solidified using radiation. The method includes providing a laser system with a housing, a construction chamber, a coating device for applying construction material in layers, a radiation device for applying the applied layers of construction material with radiation, and a group structure on which the object and/or a support structure for the object is additively constructed; forming the support structure for supporting the three-dimensional object, by successive solidification of layers of the construction material; forming individual sub-objects that form a determined section of the three-dimensional object, by successive solidification of layers of the construction material, wherein one sub-object is formed on the support structure; forming joining regions between the sub-objects for joining the sub-objects by forming the three-dimensional object; removing the three-dimensional object from the support structure.

The invention relates to a method for producing a three-dimensional object by successive solidification of layers of a powder-type construction material that can be solidified using radiation.

Such methods are generally additive processes for forming or producing three-dimensional objects or items, respectively such as technical components. The basic principle of such methods is to form the particular three-dimensional object to be produced by successive solidification of layers of a powder-type construction material that can be solidified using radiation, typically laser radiation. Known examples of such methods are, therefore, selective laser sintering, SLS in short, or selective laser melting, SLM in short.

Especially in the production of large-size three-dimensional objects, i.e., in the production of objects with large dimensions such as turbine buckets, housing structures, deformation effects related to material or process may occur, which make production of a three-dimensional object to be produced to precise final dimensions difficult.

Similarly, handling large-size three-dimensional objects during or after production regularly represents a challenge.

The invention is based on the object of providing an improved method for producing three-dimensional, especially large-size, objects by successive solidification of layers of a powder-type construction material that can be solidified using radiation.

This object is solved by a method according to claim 1. The dependent claims relate to advantageous further developments of the method according to the invention.

The method according to the invention for producing a three-dimensional object by successive solidification of layers of a powder-type construction material that can be solidified using radiation comprises the following steps:

At first, a laser sintering system or laser melting system including the usual components is provided. Said usual components are a housing with a construction chamber accommodated therein, wherein in said construction chamber a carrying device for carrying the object is provided. In addition, a coating device is available to apply construction material in layers onto a carrier or onto a layer previously applied. Using a radiation device the layers are irradiated and thus solidified on the positions corresponding to the respective cross-section of the object, for which the radiation device generally comprises a scanner for deflecting electromagnetic radiation of a radiation source generally formed as a laser. Then, a support structure is formed; this mostly happens on a base such as a construction platform. In any case, the support structure should be interconnected in its basic section. The construction of the support structure is carried out additively.
Forming several individual sub-objects that form a determined portion of the cross-section of the three-dimensional object to be produced, by successive solidification of layers of the or a powder-type construction material that can be solidified using radiation, wherein at least one sub-object is formed at least partially on the support structure;
Forming joining regions between the sub-objects for at least partially joining the sub-objects by forming the three-dimensional object; and
Removing the three-dimensional object from the support structure.

Thus, according to the method a support structure for at least partially supporting the three-dimensional object to be produced by successive solidification of layers of the or a powder-type construction material that can be solidified using radiation is formed. Thus, alongside with or in addition to forming the three-dimensional object actually to be produced, forming a support structure is also carried out, the object and function of which is explained further below. Thus, it is substantial that next to the three-dimensional object actually to be produced the support structure is also formed by successive solidification of the or a powder-type construction material that can be solidified using radiation. The support structure is thus formed in the same process in which also the three-dimensional object actually to be produced is formed.

The support structure serves as at least partial, typically full fixing or support of the three-dimensional object to be produced. The three-dimensional object to be produced is thus successively constructed on the support structure. Accordingly, the support structure in its geometric design, especially its cross-section, is adjusted or to be adjusted to the geometric design, especially the cross-section, of the three-dimensional object to be produced. In order to fulfill the supporting function described, the support structure typically represents completely the cross-section of the three-dimensional object to be produced.

Typically, the support structure comprises at least one support element, which serves as at least partial fixing or support of the or a part of the three-dimensional object to be produced. Generally, the support structure, however, comprises several support elements of equal or unequal geometric design, i.e., in particular unequal or unequal shape or equal or unequal dimensions. The support elements can be in regular or irregular arrangement. The support elements can, for example, be formed strut-like or pillar-like and can have branches.

Forming the support structure is typically carried out on a construction platform of the construction chamber of the device for performing the method, i.e., especially a device for performing a laser sintering process or a laser melting process.

At the same time or simultaneously and thus together with forming the support structure or after forming the support structure the three-dimensional object actually to be produced is formed. It is significant that the three-dimensional object is formed in segments. Thus, several individual or separated, respectively, sub-objects are formed, each forming a determined cross-sectional portion of the three-dimensional object to be produced, which, as will be explained further below, in the further process are joined or to be joined together while forming the three-dimensional object. Thus, each sub-object forms a determined part of the overall cross-section of the three-dimensional object. Thus, the three-dimensional object to be produced is not constructed continuously over its entire cross-section. Individual sub-objects each forming a determined portion of the three-dimensional object are constructed rather successively. Regarding position, the sub-objects are typically formed related to each other such that the arrangement thereof represents or makes the overall three-dimensional object.

The or a part of the sub-objects can be formed with equal or unequal geometric design, i.e., especially equal or unequal form or equal or unequal dimensions. The precise geometric design of particular sub-objects depends on said portions of the three-dimensional object to be produced that are to be represented and thus on the overall cross-section of the three-dimensional object to be produced. From this it follows that dimensions, arrangement, and orientation of particular sub-objects are formed depending on the precise dimensions of the respective object to be produced.

With the, especially cross-sectional, division or subdivision of the three-dimensional object to be produced into individual sub-objects, deformation effects related to material or production can be reduced. This is because particular deformation effects in sub-objects, which are significantly smaller in area or volume compared to the ready-made three-dimensional object, are considerably lower.

From the above explanation of the support structure it follows that the sub-objects are each at least partially supported by the support structure. The support structure similarly ensures that the sub-objects are or will be safely arranged in their relative position to each other. Thus, the support structure can be moved to each other together with the sub-objects fixed or supported by it without changing the relative position of the individual sub-objects, which means a significant advantage in terms of manageability of the three-dimensional object. Of course, an appropriate construction platform including the support structure formed thereon and the sub-objects formed thereon can also be moved to each other without changing the relative position of the individual sub-objects.

As mentioned, the individual sub-objects are to be joined together to form the three-dimensional object. According to the method it is provided that several joining regions between the individual sub-objects are formed for at least partial joining of the sub-objects while forming the three-dimensional object. During forming the appropriate joining regions, the sub-objects are typically supported by the support structure, i.e., fixed thereon, especially in their fixed relative position to each other.

Appropriate joining regions can basically be formed in any geometric design. Thus, joining regions can, for example, have a point-type, linear, or planar form. The joining regions can, at least partially, be formed as, for example, struts, bridges, strain gauges, bars, and the like or have the shape of engaging teeth or other form closure elements. It is significant that the joining regions join sub-objects adjacently arranged firmly together. Typically, one joining region joins at least two sub-objects that are arranged directly adjacent. Dimensions, arrangement, and orientation of appropriate joining regions are typically formed depending on the precise dimensions of the respective object to be produced.

Upon joining the sub-objects together, heat treatment can be performed to reduce stresses in the then joined overall component.

In a last step of the method, the three-dimensional object completely formed is removed from the support structure. The three-dimensional object can, for example, be taken off the support structure manually or (semi-)automatically. Of course, it is also possible to take the support structure off the three-dimensional object in a manual or (semi-) automated manner.

From the preceding it follows that forming the three-dimensional object actually to be produced is performed in at least two stages. In a first stage, next to the support structure, the individual sub-objects are formed. The individual sub-objects are supported by the support structure. The support similarly includes, as described, a (temporary) securing of the relative position of the individual sub-objects to each other. In another or a second stage, the individual sub-objects are joined together by forming appropriate joining regions. Hereby, the three-dimensional object actually to be produced is similarly formed.

According to the method, at least two data records are typically available, based on which solidification of the or, in general, a construction material is performed in layers to form the support structure and the sub-objects or the object. A first data record relates to the successive forming of the support structure. Thus, in the first data record all data related to the support structure is included. Another or a second data record relates to the successive forming of the object or the sub-objects. Thus, in the other or second data record all data related to the object or related to the sub-objects is included. Appropriately, the second data record especially also includes a segmented division or subdivision of the object into individual sub-objects.

In connection with forming the appropriate joining regions it is imagineable that, depending on the position of the sub-objects to be joined by them, related to the three-dimensional object to be produced, the joining regions are formed geometrically different. The geometric design, i.e., especially dimensions and shape, of appropriate joining regions can thus depend on the position at which they are located related to the three-dimensional object to be produced. The geometric design of appropriate joining regions insofar also depends on which precise sub-objects they join together. Thus, it is, for example, imaginable that joining regions joining together sub-objects arranged in outer regions, i.e., for example, edge regions of the three-dimensional object, of the three-dimensional object to be produced, are formed geometrically different than joining regions which, in comparison, join sub-objects arranged in inner regions, i.e., for example, in the region of the center of gravity or center of the three-dimensional object. In this manner, for example, locally different mechanical stresses of the finished three-dimensional object, especially in connection with a specific application or load situation, can be considered. Specifically, joining regions joining together sub-objects arranged in outer regions of the three-dimensional objects can, for example, have a point-type form, whereas joining regions which, in comparison, join together sub-objects arranged in inner regions of the three-dimensional object, can have a linear form, for example.

It is also imaginable to first join at least a part of the sub-objects using joining regions of a first geometric design only, i.e., for example, point-type joining regions, in terms of a pre-fixing or for implementation of such a pre-fixing, in order to convert the sub-objects, e.g., into a manageable state, and to form the actual joining of the sub-objects by using successively formed joining regions of a second geometric design, i.e., for example, linear joining regions, or by successively complementing the joining regions of the first geometric design, e.g., to linear joining regions. The joining regions of the first geometric design can be formed mechanically less stable than respective joining regions of the second geometric design.

As mentioned, the support structure and the sub-objects can at least partially be formed at the same time or simultaneously and thus together. It is thus possible to form at least a part of the support structure and at least a part of the sub-objects simultaneously or together. This especially applies to cases in which over a layer to be solidified in a certain part of the construction chamber according to the dimensions of the three-dimensional object to be produced one sub-object is already to be formed and in another part of the construction chamber appropriately a sub-object is not (yet) to be formed, but a part of the support structure, i.e., for example, a support element. Overall, it is thus possible to form the support structure and the three-dimensional object to be produced in a manner especially efficient from a manufacturing point of view.

Forming the joining regions can be performed outside or within the or, in general, a device for producing a three-dimensional object by successive solidification of layers of a powder-type construction material that can be solidified using radiation, especially a device for performing a laser sintering process or a laser melting process. The joining regions can be produced by a conventional welding device, i.e., be formed as welding spots or welding beads. The joining regions can, however, also be formed in the same process in which also the support structure and the sub-objects are also formed, and thus in the same device. However, this is not compelling; joining the individual sub-objects can rather be done in another process and thus in another device. The latter can, for example, be necessary when special demands are made on the joining regions, which can only be satisfactorily realized in a process separate to the process for forming the support structure as well as the sub-objects. In this context it is again to be mentioned that the individual sub-objects can readily be moved or handled by the support structure, especially by maintaining their relative position to each other, in order to reciprocate them, e.g., between devices implementing appropriate processes.

The joining regions can be formed such that they at least partially join together sub-objects that are to be arranged or are arranged next to each other and/or on top of each other. Using a joining region, both sub-objects arranged horizontally, i.e., in a horizontal plane, and sub-objects arranged vertically, i.e., in at least two horizontal planes vertically on top of each other, can thus generally be joined together.

In terms of the (further) reduction or compensation of mechanical stresses occurring related to material or process within the sub-objects or within the three-dimensional object, respectively, at least a part of the joining regions can be formed at least partially elastically such that deformation-related mechanical stresses, i.e., tensile stresses and/or compressive stresses, of the sub-objects and/or the entire three-dimensional object are at least partially reduced. The or a part of the joining regions can thus, for example, be formed through the respective geometric design thereof, i.e., especially dimensions and shape, having elastical properties due to which mechanical stresses within the or between the sub-objects can be reduced or compensated.

With the same aim it is possible that sub-objects arranged next to each other and/or on top of each other are joined such that a slot-type gap space between them is formed. Forming slot-type gap spaces, slots in short, between sub-objects respectively arranged next to each other thus provides an opportunity to reduce or compensate mechanical stresses related to material or production. Mechanical joining of particular sub-objects is not affected by forming appropriate slot-type gap spaces. The slot-type gap spaces can be dimensioned geometrically so small, i.e., so narrow, that they are not or hardly to be seen on the finished object. Typically, a particularly formed slot-type gap space has a width in a range from 1 to 100 μm, especially in a range from 10 to 30 μm. Of course, upward and downward exceptions are possible.

Forming appropriate joining regions can be performed by solidification of powder-type construction material and/or by melting on already solidified sub-object portions of respective produced sub-objects. The joining regions can thus be formed from a layer of powder-type construction material applied to the sub-objects or by again melting on already solidified sub-object portions. Joining particular sub-objects can thus be performed during forming of sub-objects as such or subsequently. Of course, a combination of both options is also possible.

It was mentioned that the sub-objects, i.e., sub-objects typically arranged adjacently, are joined together in a stable manner using appropriate joining regions. Preferably, particular sub-objects to be joined are joined by substance bonding when forming particular joining regions. Substance-to-substance bonds typically have a high mechanical load capacity or are highly mechanically stable.

Particular sub-objects to be joined using joining regions are thus preferably welded together. The joining regions thus preferably represent welded joints, i.e., the joining regions are preferably available as welding spots or welded seams or comprise such. Joining sub-objects by welding is feasible in as much as the powder-type construction materials employed according to the method can typically be welded anyway.

The three-dimensional object arranged on the support structure can be further processed or treated. Thus, it is possible, for example, that the three-dimensional object continuously arranged on the support structure is subjected to suitable post processing procedures to increase the surface quality. It is also possible to subject the three-dimensional object continuously arranged on the construction platform and/or support structure to heat treatment, for example, to reduce mechanical stresses that may be present. Heat treatment particularly includes heating of the object to a temperature below the melting temperature of the construction material used, such that a reduction of inner mechanical stresses is achieved. It is further possible to clean the three-dimensional object continuously arranged on the support structure, i.e., especially to remove construction material clinging to the surface. The list of preceding further processing options or treatment options is exemplary only and is not to be interpreted as complete.

Basically, forming the support structure and/or forming the sub-objects can, however, also be interrupted temporarily, i.e., for a certain period of time, to perform at least one measure affecting the properties of the support structure formed by then and/or the properties of the sub-objects formed by then, for example, heat treatment.

At least one sub-object can be formed with at least one reception room limiting an, especially closed, reception volume to receive at least one third item. Such a third item can, for example, be a lightweight element of a lightweight structure, e.g., constructed like a sandwich. This is particularly purposeful when the three-dimensional object produced or to be produced is an airfoil or a portion of an airfoil element forming an airfoil.

At this point, it is again to be emphasized that the method is especially suited for the production of comparatively large-size three-dimensional objects, especially technical components. As a three-dimensional object according to the method thus, e.g., a car wing element, a turbine bucket element, or an airfoil element can be produced.

According to the method, both plastic powder and metal powder can be used as powder-type construction material. Of course, plastic powder also means a plastic powder mixture of several chemically different plastics. Plastic powders can, for example, be based on polyamide or PEEK. Of course, metal powder also appropriately means a metal powder mixture of several chemically different metals or metal alloys. Metal powders can, for example, be based on aluminum or iron.

The invention further relates to a three-dimensional object produced according to the method described. Any explanation in context with the method analogously applies to the three-dimensional object. The three-dimensional object can, for example, be a car wing element, a turbine bucket element, or an airfoil element.

The invention is explained in more detail by means of exemplary embodiments in the drawings. In which:

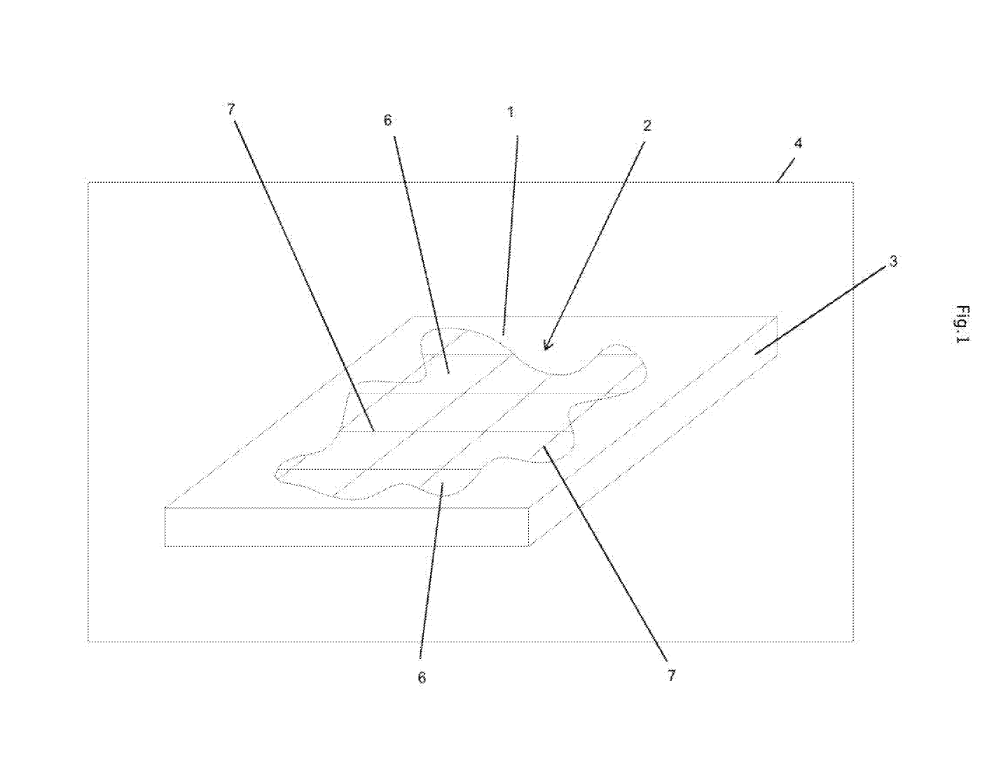

FIG. 1, 2 are each a schematic diagram to illustrate the performance of a method according to an exemplary embodiment of the invention; and

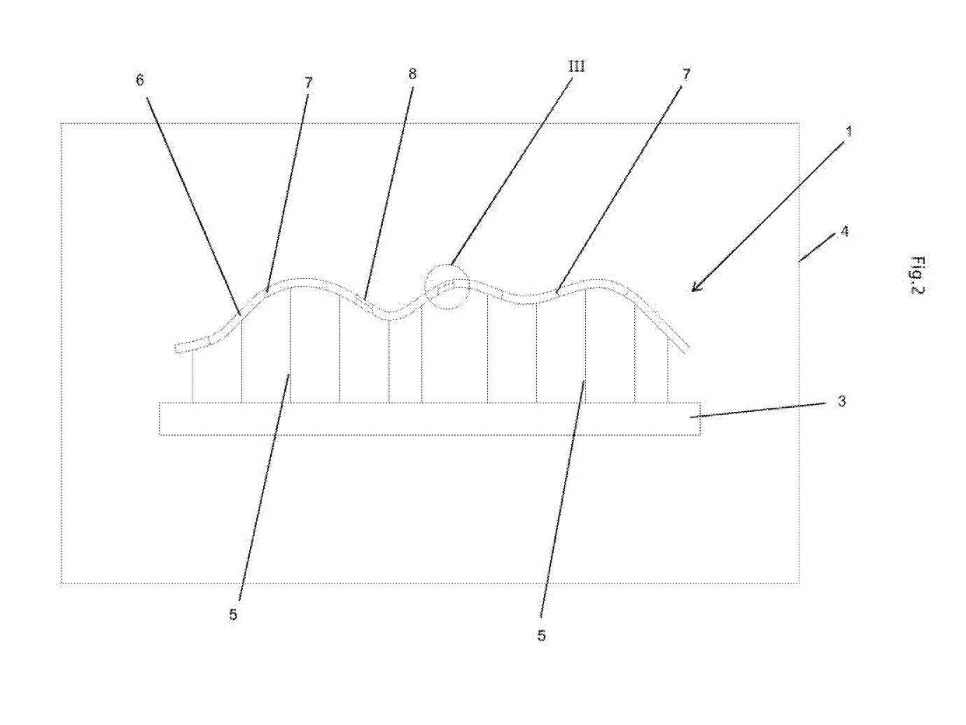

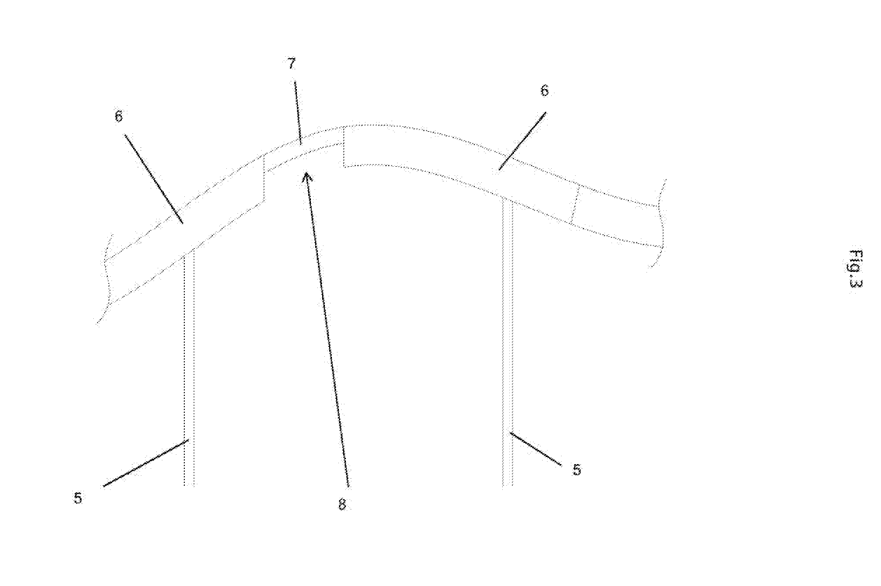

FIG. 3 is an enlarged illustration of the individual unit III shown in FIG. 2.

FIG. 1, 2 are each a schematic diagram to illustrate the performance of a method according to an exemplary embodiment of the invention.

FIG. 1 shows a perspective view of the method at a certain point in time at which a certain layer of a powder-type construction material is solidified. At this point in time, the three-dimensional object 1 is not completely produced yet. FIG. 2 is a side or cross-sectional view of the method at a certain point in time.

Using the method, three-dimensional, especially large-size, objects 1, especially technical components such as car wing elements, turbine bucket elements, airfoil elements, can be produced by successive solidification of layers of a powder-type construction material that can be solidified using radiation. Specifically, the method is a laser sintering process, SLS process in short, or a laser melting process, SLM in short.

According to the method, a support structure 2 is formed to at least partially support the three-dimensional object 1 to be produced by successive solidification of layers of a powder-type construction material that can be solidified using radiation. Then, in addition to additive forming of the three-dimensional object 1 actually to be produced, additive forming of a support structure 2 is also carried out. Therefore, the support structure 2 is also formed by successive solidification of the construction material in the same process in which the three-dimensional object 1 actually to be produced is formed.

Forming the support structure is carried out on a construction platform 3 of a construction chamber 4 of a device for carrying out the method, not shown in detail, i.e., especially a device for carrying out a laser sintering process or a laser melting process.

The support structure 2 serves for fixing or support of the three-dimensional object to be produced. The three-dimensional object 1 to be produced is successively constructed onto the support structure 2. Accordingly, the support structure 2 in its geometric design, especially in its cross-section, is adapted to the geometric design, especially the cross-section, of the three-dimensional object 1 to be produced (cf. FIG. 2). The support structure 2 fully represents the cross-section of the three-dimensional object 1 to be produced in the exemplary embodiments shown in the figures.

As can be seen in FIG. 1, support structure 2 comprises several support elements 5.

The support elements 5 can be of equal or unequal geometric design, i.e., equal or unequal shape or equal or unequal dimensions, and can be arranged in regular or irregular manner. The support elements 5 shown in the figures are formed strut-like or pillar-like.

The three-dimensional object 1 that is typically formed simultaneously with the support structure 2 is formed in segments. Thus, several individual or separate sub-objects 6 are formed, each forming a certain cross-sectional portion of the three-dimensional object 1 to be produced. As results from FIG. 2, each sub-object 6 forms a certain portion of the overall cross-section of three-dimensional object 1. Thus, the three-dimensional object to be produced is not constructed over its entire cross-section, but individual sub-objects 6 are constructed successively. Regarding position, the sub-objects 6 are formed related to each other such that the arrangement thereof makes the overall cross-section of the three-dimensional object 1.

With the, especially cross-sectional, division or subdivision of the three-dimensional object 1 to be produced into individual sub-objects 6, deformation effects related to material or production are reduced, since particular deformation effects in the sub-objects, which are considerably smaller in area or volume compared to the finished three-dimensional object, are, if at all, definitely smaller.

The support structure 2 and the sub-objects 6 can, as mentioned, be formed at the same time or simultaneously and thus together. From FIG. 2 it can be seen that one sub-object 6 is already to be formed over a layer of powder-type construction material to be solidified in a certain portion of the construction chamber 4, here outer regions, according to the dimensions of the three-dimensional object 1 to be produced, and in another portion of the construction chamber 4, here inner regions, no sub-object 6 is to be formed (yet), but a portion of the support structure 2, i.e., support elements 5, is to be formed.

The support structure 2 ensures that the sub-objects 6 are or will be safely arranged in their relative position to each other. Thus, the support structure 2 can be moved to each other or handled together with the sub-objects 6 fixed or supported by this without changing the relative position of the individual sub-objects 6. Of course, the construction platform 3 together with the support structure 2 formed thereon and the sub-objects 6 formed thereon can also be moved to each other without changing the relative position of the individual sub-objects 6.

For joining the sub-objects 6, joining regions 7 between the sub-objects 6 for at least partially joining the sub-objects 6 are formed during forming of the three-dimensional object 1. During forming of the joining regions 7 shown in the figures as a bold line, the sub-objects 6 are generally supported or fixed by the support structure 2. Forming particular joining regions 7 can be carried out by solidification of powder-type construction material and/or by melting on already solidified sub-object portions of particular produced sub-objects 6.

The joining regions 7 join the sub-objects 6 typically by substance bonding. The substance-by-substance bond is typically carried out using welding joints; thus sub-objects 6 are typically welded together.

Appropriate joining regions 7 can basically be formed in any geometric design. In FIG. 1, both point-type and linear joining regions 7 are exemplarily shown.

Appropriate joining regions 7 can be designed geometrically different depending on the position of the sub-objects 6 to be joined by using them related to the three-dimensional object 1 to be produced. The geometric design, i.e., especially dimensions and shape, of appropriate joining regions 7 can thus depend on the position at which they are located related to the three-dimensional object 1 to be produced. In FIG. 1, merely exemplary joining regions 7 that join together sub-objects arranged in outer regions of the three-dimensional object 1 mainly have a point-type form, whereas joining regions 7 that join together sub-objects 6 that are, in comparison, arranged in inner regions of the three-dimensional object 1 mainly have a linear form.

It is also imaginable to first join a part of the sub-objects 6 using joining regions 7 of a first geometric design only, e.g., point-type joining regions 7, to implement a pre-fixing, to convert sub-objects 6, e.g., into a manageable state, and to form the actual joining of the sub-objects 6 by using successively formed joining regions 7 of a second geometric design, e.g., linear joining regions 7, or by successively complementing the joining regions 7 of the first geometric design, e.g., to linear joining regions. Appropriate joining regions 7 of the first geometric design can be formed mechanically less stable than respective joining regions 7 of the second geometric design.

Forming appropriate joining regions 7 can be performed outside or within the device implementing the method. Consequently, the joining regions 7 can also be formed in the same process in which also the support structure 2 and the sub-objects 6 are formed.

In terms of the (further) reduction or compensation of mechanical stresses occurring related to material or process within the sub-objects or within the three-dimensional object, individual or several joining regions 7 can be formed at least partially elastically such that deformation-related mechanical stresses, i.e., tensile stresses and/or compressive, of the sub-objects 6 or the entire three-dimensional object 1 can at least be partially reduced. The joining regions 7 can thus, for example, be formed through the respective geometric design thereof, having elastical properties due to which mechanical stresses within the or between the sub-objects 6 can be reduced or compensated.

Appropriately, sub-objects 6 arranged next to each other and/or on top of each other are joined together using appropriate joining regions 7 such that a slot-type gap space 8, i.e., a slot, is formed or remains between them. Such a slot-type gap space 8 is shown in FIG. 3. Forming slot-type gap spaces 8 between sub-objects 6 arranged next to each other is also an opportunity to reduce or compensate mechanical stresses related to material or production. Mechanical joining of particular sub-objects is not affected by forming appropriate slot-type gap spaces. The slot-type gap spaces 8 are typically dimensioned so small, i.e., so narrow, that they are not or hardly to be seen on the finished object 1. Typically, the slot-type gap spaces 8 have a width in a range from 1 to 100 μm, especially in a range from 10 to 30 μm.

In a last step of the method, the three-dimensional object 1 completely formed is taken off, e.g., manually or (semi-)automatically, the support structure 2.

Prior to taking the three-dimensional object 1 off the support structure 2 or the construction platform, the three-dimensional object 1 can, however, be processed or treated. Thus, it is possible, for example, to subject the three-dimensional object 1 arranged on the support structure 2 to suitable post processing procedures to increase the surface quality. It is also possible to subject the three-dimensional object 1 continuously arranged on the support structure 2 to heat treatment to relieve inner mechanical stresses that may be present. It is further possible to clean the three-dimensional object 1 continuously arranged on the support structure 2, i.e., especially to remove construction material clinging to the surface.

In order to perform at least one measure affecting the properties of the support structure 2 formed by then and/or the properties of the sub-objects 6 formed by then, i.e., for example, heat treatment, forming the support structure 2 and/or forming the sub-objects 6 can also be interrupted temporarily, i.e., fora certain period of time.

One or more sub-objects 6 can be formed with a reception room that is limiting the, especially closed, reception volume to receive at least one third item. Such a third item can, for example, be a lightweight element of a lightweight structure, e.g., constructed like a sandwich. This is particularly purposeful when the three-dimensional object 1 is an airfoil or a portion of an airfoil element forming an airfoil.

### LIST OF REFERENCE NUMBERS

1 Object

2 Support structure

3 Construction platform

4 Construction chamber

5 Support element

6 Sub-object

7 Joining region

8 Gap space

1. A method for producing a three-dimensional object (1) by successive solidification of layers of a powder-type construction material that can be solidified using radiation, said method comprising the following steps:
providing a laser sintering system or a laser melting system with a housing, a construction chamber arranged therein, a coating device for applying construction material in layers, a radiation device for radiating the applied layers of construction material, and a group structure on which the object and/or a support structure for the object is additively constructed;
characterized by the following steps
forming the support structure (2) for at least partially supporting the three-dimensional object (1) to be produced, by successive solidification of layers of the construction material;
forming a number of individual sub-objects (6) that form a determined section of the three dimensional object (1) to be produced, by successive solidification of layers of the construction material, wherein at least one sub-object (6) is formed at least partially on the support structure (2);
forming joining regions (7) between the sub-objects (6) for at least partially joining the sub-objects (6) by forming the three-dimensional object;
removing the three-dimensional object (1) from the support structure (2).

2. A method according to claim 1, characterized in that at least a part of the support structure (2) and at least a part of at least one sub-object (6) are formed simultaneously.

3. A method according to claim 1, characterized in that forming the joining regions (7) is performed outside or within the SLS or SLM system.

4. A method according to claim 1,
characterized in that the joining regions (7) are formed such that they join together sub-objects (6) that are, at least partially, arranged or to be arranged next to each other and/or on top of each other.

5. A method according to claim 1,
characterized in that the joining regions (7) are designed geometrically different depending on the position of the sub-objects (6) to be joined using these joining regions related to the three-dimensional object (1) to be produced.

6. A method according to claim 1,
characterized in that at first at least a part of the sub-objects (6) is joined using joining regions (7) of a first, especially point-type, geometric design, in order to convert the sub-objects (6) joined in this manner into a manageable state, and successively joining regions (7) of a second, especially linear, geometric design are formed and/or joining regions (7) of the first geometric design already formed are successively completed by forming, especially linear, joining regions (7) of the second geometric design.

7. A method according to claim 1,
characterized in that at least a part of the joining regions (7) is at least partially formed elastically such that deformation-related mechanical stresses of the sub-objects (6) and/or of the object (1) are reduced.

8. A method according to claim 1,
characterized in that sub-objects (6) arranged next to each other and/or on top of each other are joined such that a slot-type gap space (8) is formed between them.

9. A method according to claim 1,
characterized in that forming appropriate joining regions (7) is performed by solidification of powder-type construction material and/or by melting on already solidified sub-object portions of already produced sub-objects (6).

10. A method according to claim 1,
characterized in that appropriate sub-objects (6) to be joined are joined together by forming appropriate joining regions (7) by substance bonding.

11. A method according to claim 10, characterized in that the appropriate sub-objects (6) to be joined are welded together.

12. A method according to claim 1,
characterized in that forming the support structure (2) and/or forming the sub-objects (6) is interrupted temporarily, to perform at least one measure affecting the properties of the support structure (2) formed by then and/or the properties of the sub-objects (6) formed by then, for example, heat treatment.

13. A method according to claim 1,
characterized in that at least two of the appropriate sub-objects (6) are formed with equal or different geometric design.

14. A method according to claim 1,
characterized in that at least one sub-object (6) is formed with at least one reception room limiting the, especially closed, reception volume for reception of at least one third item.

15. A three-dimensional object (1) produced according to a method of claim 1.
